(19) United States
(12) Patent Application Publication
(10) Pub. No.: US 2003/0211350 A1
(43) Pub. Date: Nov. 13, 2003

(54) Multilayer heat sealable polyolefin film comprising skin layer and transition layer of differing melting points

(76) Inventors: Robert A. Migliorini, North Haven, CT (US); Salvatore J. Pellingra, Wolcott, NY (US); Karen A. Sheppard, Victor, NY (US); David A. Liestman, North Haven, CT (US)

Correspondence Address: EXXONMOBIL CHEMICAL COMPANY, P O BOX 2149, BAYTOWN, TX, 77522-2149, US

(21) Appl. No.: 10/143,371

(22) Filed: May 10, 2002

(51) Int. Cl. B32B 27/08

(52) U.S. Cl. 428/515; 428/500

(57) ABSTRACT

A thermoplastic multilayer film having improved processability and sealability comprises: a) a core layer comprising a polyolefin selected from the group consisting of isotactic PP homopolymer, EP copolymer, HDPE, and LLDPE; b) a first transition layer external to the core layer wherein the first transition layer comprises a polyolefin selected from the group consisting of syndiotactic PP, EP copolymer, PB copolymer, EPB terpolymer, MDPE, LLDPE, LDPE, metallocene-catalyzed PE, EVA copolymer, EMA copolymer, and ionomer; and c) a first skin layer external to the first transition layer and the core layer wherein the first skin layer comprises a polyolefin selected from the group consisting of PP homopolymer, HDPE, EP copolymer, PB copolymer, EPB terpolymer, MDPE, and LLDPE, the first skin layer being at least 0.5 micron in thickness with a melting point at least 5° C. greater than the first transition layer.

### FIELD OF THE INVENTION

The present invention relates to heat sealable oriented propylene polymer film having increased seal temperature range. The film comprises a multiplex heat seal layer and a propylene polymer core.

### BACKGROUND OF THE INVENTION

In the packaging of certain types of foods, such as cookies, potato chips, and the like, it is common practice to employ a multilayer film having two or more polymeric layers wherein one of the layers is known to be an effective heat seal layer. In the packaging process, a supply of such a multilayer film can be shaped into a tube in a vertical form and fill machine. Marginal regions of the heat seal layer are brought into face-to-face relationship and heat sealed together. Thereafter, the packaging machine automatically forms a heat seal and makes a horizontal severance across the bottom of the bag. Next, product is dispensed into the open end of the tube and, thereafter, a second horizontal seal is effected across the tube with a simultaneous severing through the tube to result in a product packaged in a tube, heat sealed at both ends and along one seam at right angles to the end seals.

Traditionally, heat sealable oriented polyolefin films such as oriented polypropylene (OPP) are produced by coextruding a lower melting point ethylene-propylene copolymer (EP copolymer), ethylene-propylene-butylene terpolymer (EPB terpolymer) or propylene-butylene copolymer (PB copolymer) on a polypropylene homopolymer (PP homopolymer) core. Such products can be improved by broadening the seal temperature range, i.e., the temperature at which heat sealing can be effected. Improved sealability can be obtained by broadening heat sealing temperature ranges or reducing the minimum sealing temperature.

Heat sealing temperature ranges can be increased by utilizing lower melting point and higher comonomer content (reduced propylene content) PB copolymers, EP copolymers and EPB terpolymers as skin layers. Unfortunately, this can create difficulties in fitness-for-make (FFM) processability properties such as sticking during machine direction orientation (MDO), resulting in increased downtime for cleaning roll surfaces. Lowering MDO temperatures to reduce sticking of the film to the rolls used therein, renders the stretching process less stable and less robust, with an increased propensity for web breakage in the machine direction. In addition, difficulties arise in handling the film resulting from an overly tacky film surface.

Other FFM problems associated with lowered melt temperature in the skin layers include sticking and melting of polymer on the transverse direction orienter (TDO) clips. With film structures utilizing two skin layers of MDPE, LLDPE, or HDPE, there can be problems with pinning of the melt coming out of the die on the cast roll which destabilizes the casting process. Finally, during the melt coextrusion process, a propensity for layer to layer interfacial instability (“melt disturbance”) results in films having an undesirable appearance.

Fitness-for-use (FFU) properties may also be compromised when the lower melting point materials are used in the heat sealable skin layer. For example, susceptibility to surface scratches during manufacture can arise from an overly soft film surface. Moreover, while sealability improves from the use of lower melting skin resins, coefficient of friction (COF), hot slip, blocking resistance and hot tack properties may be compromised. As a result, it may be necessary to add or increase the levels of antiblock and slip agents to improve the surface properties of the film. Moreover, many types of sealable resins, e.g., metallocene-catalyzed LLDPE, LDPE, etc., cannot be used as skin layers on OPP films because they stick to the rolls during MDO or possess poor hot tack. Indeed, for some of these lower melting point resins, the MDO temperatures cannot be lowered enough to eliminate sticking while maintaining sufficient heat to adequately stretch the polypropylene base sheet in the machine direction.

U.S. Pat. No. 4,345,004 to Miyata et al. relates to a homopolymer polypropylene core layer co-extruded with an ethylene propylene copolymer which is biaxially oriented. The copolymer layer is corona treated and can be subjected to metal coating by vacuum deposition.

U.S. Pat. No. 4,439,493 to Hein et al., discloses an oriented heat sealable structure which comprises a polyolefin film substrate, a layer consisting essentially of a random copolymer of ethylene and propylene having from about 0.5% to about 6% by weight of ethylene on at least one surface of the substrate, a primer coating on at least one surface of the random copolymeric layer and a heat sealable layer on the primer coating, wherein the heat sealable layer comprises an interpolymer comprising a minor amount of acrylic acid, methacrylic acid or mixtures thereof and a minor amount of neutral monomer esters comprising methyl acrylate, ethyl acrylate or methyl methacrylate.

U.S. Pat. No. 4,564,558 to Touhsaent et al., discloses a multilayer oriented heat sealable structure, comprising a polyolefin film substrate, a layer comprising a terpolymer of propylene with ethylene and butene-1, a primer coating on at least one surface of the terpolymer layer and a heat sealable layer on the primer coating, wherein the heat sealable layer is selected from the group consisting of a vinylidene chloride polymer layer and an acrylic polymer layer.

U.S. Pat. No. 5,093,194 to Touhsaent et al., incorporated herein by reference, discloses a multilayer oriented heat sealable structure, comprising a polyolefin film substrate, having on one surface a polymeric heat sealable layer comprising a terpolymer of propylene with ethylene and butene-1, and on the other a primer coating having thereon a water vapor and gas barrier layer comprising PVdC and inter polymer of acrylic acid and neutral monomer esters, e.g., methyl acrylate.

U.S. Pat. No. 5,194,318 to Migliorini et al., incorporated herein by reference, discloses a metallized oriented film combination comprising a propylene homopolymer or copolymer substrate having a high density polyethylene skin layer with a thin metal layer deposited thereon. Optionally, the film combination can comprise a heat sealable polymer layer as well.

U.S. Pat. No. 5,527,608 to Kemp-Patchett et al. discloses a biaxially oriented heat sealable multilayer film structure, suited for use in high altitude applications, which comprises: (a) a core substrate having two surfaces, comprising i) a layer of homopolymer polyolefin and ii) a layer of block copolymer of ethylene and propylene having a MFR of 1 to 10, adjacent to at least one side of i); (b) a polymeric heat sealable layer on one surface of said core substrate, said heat sealable layer comprising a polymeric material selected from the group consisting of a terpolymer of ethylene, propylene and butene-1, a random copolymer of ethylene and propylene, a random copolymer of propylene and butene-1, and blends thereof; and optionally, (c) a high density polyethylene (HDPE) layer adjacent to the other surface of said core substrate (a).

U.S. Pat. No. 5,851,640 to Schuhmann et al. discloses a sealable transparent, biaxially oriented multilayer polypropylene film comprising a polypropylene polymer core layer, an intermediate layer comprising a polypropylene polymer, e.g., homopolymer propylene or E-P copolymer, and a sealable top layer of no greater than 0.4 micron thickness comprising a polyolefin copolymer or terpolymer.

U.S. Pat. No. 5,817,412 to Lohmann et al. discloses a sealable multilayer polypropylene film comprising a polypropylene polymer core layer, an intermediate layer comprising a polypropylene polymer, e.g., homopolymer propylene or E-P copolymer, and a sealable top layer of no greater than 0.4 micron thickness comprising a polyolefin copolymer or terpolymer. The minimum sealing temperature of the polyolefin of the top layer is at least 100° C. and is greater than the minimum sealing temperature of the polyolefin of the intermediate layer. The reference teaches that the operability of the film depends on providing a top layer of less than 0.4 micron which is broken open by the ribbing of the sealing jars during processing. However, films comprising such thin layers can be difficult to process because of “melt disturbance” between the skin layer and the core layer and variations in skin layer thickness for such thin skins.

It would be desirable to provide a multilayer film which has a sufficiently low melting temperature to provide improved sealability while maintaining adequate coefficient of friction (COF), hot slip, blocking resistance, stickiness and hot tack properties. Moreover, it would be desirable to provide a multilayer film with improved processability, e.g., by including reducing sticking during machine direction orientation, polymer melting onto transverse direction orienter clips. Inasmuch as conventional multilayer materials employ skin layers having lower melting points relative to interior layers, the resulting enhanced sealability is associated with undesirable side effects resulting from use of lower melting point materials in the outer skin layer which can reduce fitness for use as well as fitness of make properties. It would also be desirable to provide a multilayer film having improved sealability while maintaining fitness for use (FFU) and fitness for make properties (FFM).

### SUMMARY OF THE INVENTION

In one aspect, the present invention relates to a thermoplastic multilayer film comprising: a) a core layer comprising a polyolefin selected from the group consisting of isotactic PP homopolymer, EP copolymer, HDPE, and LLDPE; b) a first transition layer external to said core layer wherein said first transition layer comprises a polyolefin selected from the group consisting of syndiotactic PP, EP copolymer, PB copolymer, EPB terpolymer, MDPE, metallocene-catalyzed LLDPE, LDPE, metallocene-catalyzed PE, EVA copolymer, EMA copolymer, and ionomer; and c) a first skin layer external to the first transition layer and the core layer wherein said first skin layer comprises a polyolefin selected from the group consisting of PP homopolymer, HDPE, EP copolymer, PB copolymer, EPB terpolymer, MDPE, and LLDPE, said first skin layer being at least 0.5 micron in thickness with a melting point at least 5° C. greater, at least 1° C. greater, or even at least 15° C. greater, than said first transition layer.

In another aspect, the present invention relates to a multilayer film of the type described above wherein the core layer comprises HDPE and said first skin layer comprises a polyolefin selected from the group consisting of HDPE, MDPE, and LLDPE.

In yet another aspect, the multilayer film of the present invention has a core layer comprising isotactic PP homopolymer, a first transition layer comprising a polyolefin selected from the group consisting of syndiotactic PP, EP copolymer, PB copolymer, EPB terpolymer, and metallocene-catalyzed LLDPE; and a first skin layer comprising a polyolefin selected from the group consisting of PP homopolymer, HDPE, EP copolymer, PB copolymer, and EPB terpolymer.

In still another aspect, the multilayer film has a core layer comprising isotactic PP homopolymer, a first transition layer comprising a polyolefin selected from the group consisting of syndiotactic PP, EP copolymer, EPB terpolymer, and PB copolymer, a first skin layer comprising a polyolefin selected from the group consisting of MDPE, LLDPE, and HDPE, the first skin layer being at least 0.5 micron in thickness with a melting point at least 5° C. greater than the first transition layer; the multilayer film further comprising:

d) a second transition layer external to the core layer and on a side of the core layer opposite the first transition layer, the second transition layer comprising a polyolefin selected from the group consisting of EP copolymer, EPB terpolymer, PB copolymer, syndiotactic PP, metallocene-catalyzed LLDPE, and PP homopolymer; and

e) a second skin layer external to the second transition layer and on a side of the core layer opposite the first skin layer, the second skin layer comprising a polyolefin selected from the group consisting of HDPE, MDPE, and LLDPE. The multilayer film's second skin layer can be at least 0.5 micron in thickness with a melting point at least 5° C. greater than the second transition layer.

In another aspect of the invention, the multilayer film comprises the first aspect of the invention further limited by a) a core layer which comprises isotactic PP homopolymer, b) a first transition layer which comprises a polyolefin selected from the group consisting of syndiotactic PP, EP copolymer, EPB terpolymer, and PB copolymer, and metallocene-catalyzed LLDPE, c) a first skin layer which comprises a polyolefin selected from the group consisting of PP homopolymer, HDPE, EP copolymer, PB copolymer, and EPB terpolymer, d) a second transition layer external to said core layer and on a side of said core layer opposite said first transition layer, said second transition layer comprising a polyolefin selected from the group consisting of syndiotactic PP, EP copolymer, EPB terpolymer, and PB copolymer, and metallocene-catalyzed LLDPE, and e) a second skin layer external to said second transition layer and on a side of said core layer opposite said first skin layer, said second skin layer comprising a polyolefin selected from the group consisting of PP homopolymer, HDPE, EP copolymer, PB copolymer, and EPB terpolymer, said second skin layer being at least 0.5 micron in thickness with a melting point at least 5° C. greater than said second transition layer.

In still another aspect, the multilayer film of the present invention has a first skin layer further comprising an anti-blocking agent and wherein at least a major proportion of the anti-blocking agent is in the form of particles of approximately spherical shape. The anti-blocking agent can be selected from the group consisting of amorphous silica, cross-linked methacrylate, and polymethylsilsesquioxane.

In still yet another aspect of the present invention, the core layer further comprises an additive selected from the group consisting of:

i) an opacifying agent selected from the group consisting of iron oxide, carbon black, aluminum, TiO₂, and talc, said opacifying agent being present in said core layer in an amount ranging from about 1 wt % to about 15 wt %, based on the total weight of the core layer;

ii) a cavitating agent selected from the group consisting of polybutene teraphthalate, nylon, solid glass spheres, hollow glass spheres, metal beads, metal spheres, ceramic spheres, and CaCO₃, said cavitating agent being present in said core layer in an amount ranging from about 1 wt % to about 20 wt %, based on the total weight of the core layer, said cavitating agent having a mean particle size in the range of from 0.1 micron to 10 microns; and

iii) a hydrocarbon resin selected from the group consisting of petroleum resin, terpene resin, styrene resin, cyclopentadiene resin, and saturated alicyclic resin, said resin having an average molecular weight of less than about 5000, a softening point in the range of from about 60° to about 180° C., and said resin being present in said core layer at less than about 15 wt %, based on the total weight of the core layer.

In another aspect, the multilayer film of the present invention has a core layer comprising at least about 60 percent of the total thickness of the film.

In one aspect, the multilayer film of the present invention can have a total thickness from about 7 microns to about 75 microns, preferably from about 12 microns to about 50 microns, say from about 15 microns to about 35 microns. The first transition layer (and second transition layer, where present) of the film can have a thickness of from about 0.5 to about 10 microns, preferably from about 0.7 to about 3 microns, say, from about 1 microns to about 2 microns.

In still another aspect, the multilayer film of the present invention can have an exposed surface of the first skin layer treated by a procedure selected from the group consisting of corona treatment, flame treatment, and plasma treatment.

In yet another aspect, the multilayer film of the present invention can have an exposed surface of the core layer treated by a procedure selected from the group consisting of corona treatment, flame treatment, and plasma treatment.

In still another aspect of the present invention, the first skin layer (and/or the second skin layer, if present) can be coated with a coating selected from the group consisting of acrylics, PVDC, and PVOH.

In another aspect, the multilayer film of the present invention can have an external, i.e., exposed, side of the core layer coated with a coating selected from the group consisting of acrylics, PVDC, and PVOH.

In another aspect, an external side of the first skin layer (and/or second skin layer, if present) can be vacuum metallized with a suitable metal, e.g., one selected from the group consisting of aluminum, silver and gold, preferably aluminum.

In still another aspect, the multilayer film of the present invention comprises a second skin layer on a side of said core layer opposite said first skin layer. Preferably, the second skin layer comprises a polyolefin selected from the group consisting of PP homopolymer, EP copolymer, EPB terpolymer, PB copolymer, MDPE, LLDPE, and HDPE. Preferably, the multilayer film will also comprise a second transition layer interposed between the core layer and the second skin layer. Preferably, the second transition layer is selected from the group consisting of syndiotactic PP, EP copolymer, PB copolymer, EPB terpolymer, and metallocene-catalyzed LLDPE.

In another aspect, the multilayer film of the present invention comprises a first skin layer having a variation in thickness of no greater than 0.10μ preferably no greater than 0.05μ, say, no greater than 0.025μ.

In still another aspect, the multilayer film itself has a variation in thickness of no greater than 1.0μ, preferably no greater than 0.70μ, say, no greater than 0.5μ.

In yet another aspect, the multilayer film of the present invention has improved processability compared to corresponding films of the prior art; e.g., those whose differences in melting point between the first skin layer and first transition layer are less than 5° C. Such improved processability is characterized by at least one of: improved coextrusion interfacial layer to layer stability, improved casting stability; e.g. as characterized by improved adhesion to the cast roll; improved MDO draw line stability (as measured by decreased frequency of unstretched areas after MD stretching), less film sticking on MDO rollers, improved machine direction stretching stability; e.g. as characterized by fewer web breaks in the MDO; less film sticking on TDO clips, less of a propensity for surface scratching, and less downtime for roll cleaning. Preferably the multilayer film of the present invention has more than one, or more preferably all, of the preceding characteristics.

Increased coextrusion interfacial layer to layer stability can be measured by nonuniformity of the sheet quality after casting. Improved casting stability can be characterized by improved adhesion to the cast roll, as measured by improved uniformity of sheet width exiting from the casting process. MDO draw line stability can be measured by decreased frequency of unstretched areas in the film. Less film sticking on MDO rollers can be determined by empirical observation or decreased frequency of surface defects in the film. Machine direction stretching stability can be characterized by fewer web breaks in the MDO under comparable conditions, as empirically observed. Film sticking on TDO clips and MDO rollers can be observed empirically. Melting point of skin layer polymer can be measured by differential scanning calorimetry. Coefficient of friction (COF) of skin layer as measured by ASTM D1894, and less film sticking on MDO rollers. Surface scratching can be measured by visual observation of scratch frequency. Downtime for roll cleaning is empirically observed.

In another aspect, the multilayer film of the present invention has improved sealability compared to corresponding films of the prior art, e.g., those whose differences in melting point between the first skin layer and first transition layer are less than 5° C., as characterized by at least one of lower minimum sealing temperature, higher heat seal strength (g/inch as measured by ASTM F88), improved hot tack strength (g/inch as measured by Industry Strength Test, and lower minimum sealing temperature (MST), preferably having more than one, or more preferably all, of the preceding characteristics.

In an additional aspect, the present invention relates to a thermoplastic multilayer film comprising: a) a core layer comprising HDPE; b) a first transition layer external to said core layer wherein said first transition layer comprises a polyolefin selected from the group consisting of syndiotactic PP, EP copolymer, PB copolymer, EPB terpolymer, MDPE, metallocene-catalyzed LLDPE, LDPE, metallocene-catalyzed PE, EVA copolymer, EMA copolymer, and ionomer; and c) a first skin layer external to the first transition layer and the core layer wherein said first skin layer comprises a polyolefin selected from the group consisting of HDPE, MDPE, and LLDPE.

In still another aspect, the present invention relates to a thermoplastic multilayer film comprising: a) a core layer comprising isotactic PP homopolymer; b) a first transition layer external to said core layer wherein said first transition layer comprises a polyolefin selected from the group consisting of EP copolymer, EPB terpolymer, PB copolymer, metallocene-catalyzed LLDPE, and syndiotactic PP; and c) a first skin layer external to said first transition layer and said core layer wherein said first skin layer comprises a polyolefin selected from the group consisting of HDPE, LLDPE, and MDPE, said first skin layer being at least 0.5 micron in thickness. The first skin layer can have a melting point at least 5° C. greater than said first transition layer.

In yet another aspect, the present invention relates to the immediately preceding embodiment which further comprises: d) a second transition layer external to said core layer and on a side of said core layer opposite said first transition layer, said second transition layer comprising a polyolefin selected from the group consisting of EP copolymer, EPB terpolymer, PB copolymer, syndiotactic PP, metallocene-catalyzed LLDPE, and PP homopolymer; and e) a second skin layer external to said second transition layer and on a side of said core layer opposite said first skin layer, said second skin layer having at least 0.5 micron thickness and comprising a polyolefin selected from the group consisting of HDPE, MDPE, and LLDPE. The first skin layer can have a melting point at least 5° C. greater than said first transition layer and said second skin layer can have a melting point at least 5° C. greater than said second transition layer.

In still another aspect, the present invention relates to a method of making a biaxially oriented, surface treated multilayer thermoplastic film comprising the steps of: 1) coextruding a multilayer melt of polyolefin polymers through a die, said melt comprising a) a core layer comprising a polyolefin selected from the group consisting of isotactic PP homopolymer, EP copolymer, HDPE, and LLDPE; b) a first transition layer external to the core layer wherein said first transition layer comprises a polyolefin selected from the group consisting of syndiotactic PP, EP copolymer, PB copolymer, EPB terpolymer, MDPE, metallocene-catalyzed LLDPE, LDPE, metallocene-catalyzed PE, EVA copolymer, EMA copolymer, and ionomer; and c) a first skin layer external to the first transition layer and the core layer wherein the first skin layer comprises a polyolefin selected from the group consisting of PP homopolymer, HDPE, EP copolymer, PB copolymer, EPB terpolymer, MDPE, and LLDPE, the first skin layer being at least 0.5 micron in thickness with a melting point at least 5° C. greater than the first transition layer; 2) cooling said multilayer melt to form a multilayer film; 3) stretching said multilayer film in the machine direction (MD) over heated rollers traveling at a differential speed to form an MD oriented multilayer film; 4) stretching said MD oriented multilayer film in transverse direction in a heated tenter frame to form a biaxially oriented multilayer film; and 5) surface treating one or more exposed surfaces of said biaxially oriented multilayer film with a treatment selected from the group consisting of corona treatment, flame treatment, and plasma treatment.

In another aspect of this embodiment of the method of the present invention, said first skin layer comprises a polyolefin selected from the group consisting of HDPE, MDPE, and LLDPE.

In still yet another aspect of this embodiment of the method of the present invention, said cooling is carried out by contacting said skin layer of said multilayer melt with a casting roll.

In yet another aspect of this embodiment of the method of the present invention, said melt further comprises

d) a second transition layer external to said core layer and on a side of said core layer opposite said first transition layer, said second transition layer comprising a polyolefin selected from the group consisting of EP copolymer, EPB terpolymer, PB copolymer, syndiotactic PP, and PP homopolymer; and

e) a second skin layer external to said second transition layer and on a side of said core layer opposite said first skin layer, said second skin layer comprising a polyolefin selected from the group consisting of HDPE, MDPE, and LLDPE.

In an alternative embodiment of the above method of the invention, said cooling is carried out by contacting one of said skin layers of said multilayer melt with a casting roll. The other skin layer can be cooled by contacting with a water bath.

In another aspect of the method of the invention, the width of said skin layer is narrower than its underlying transition layer as it is exiting the die.

In still another alternative embodiment of the method of the present invention, said width is sufficiently narrow to allow contact of said immediately underlying transition layer with said casting roll to an extent sufficient to increase friction between said multilayer melt and said casting roll as compared to a corresponding multilayer melt whose skin layer and underlying transition layer have the same width. This provides for improved adhesion of the melt to the cast roll surface which improves quench uniformity, and hence sheet quality exiting from the cast roll.

In still yet another alternative embodiment of the method of the present invention, the width of said skin layer ranges from 70 to 95% of said transition layer, say, 75 to 85% of said transition layer.

In still another aspect, the present invention relates to a thermoplastic multilayer film comprising: A) a core layer comprising a polyolefin; B) a first transition layer external to the core layer wherein the first transition layer comprises a polyolefin; and C) a first skin layer external to the first transition layer wherein the first skin layer comprises a polyolefin, is at least 0.5 micron in thickness, and has a melting point at least 5° C. greater than the first transition layer, the film having a variability in thickness no greater than 1.0 micron, preferably no greater than 0.7 micron, say, no greater than 0.5 micron.

In accordance with the present invention there is provided a thermoplastic multilayer film comprising: a) a core layer comprising a propylene polymer wherein the core layer comprises an interior and an exterior side of the multilayer film; b) a first transition layer exterior to the core layer wherein the first transition layer comprises a polyolefin; and c) a first skin layer exterior to the first transition layer wherein the first skin layer comprises a polyolefin, is at least 0.5 micron in thickness, and has a melting point at least 5° C. greater than the first transition layer; said multilayer film having a variability in thickness no greater than 1.0 micron.

In still another aspect, the present invention provides a method for producing an oriented heat sealable multilayer film structure. The method comprises:

(A) coextruding a coextrudate comprising:

a) a core layer comprising a polyolefin wherein said core layer comprises an interior and an exterior side of said multilayer film;

b) a first transition layer exterior to said core layer wherein said first transition layer comprises a polyolefin; and

c) a first skin layer exterior to said first transition layer wherein said first skin layer comprises a polyolefin, is at least 0.5 micron in thickness, and has a melting point at least 5° C. greater than said first transition layer; and

B) biaxially orienting the coextrudate, providing a multilayer film having a variability in thickness no greater than 1.0 micron, preferably no greater than 0.7 micron, say, no greater than 0.5 micron.

These and other features, aspects and advantages of embodiments of our invention, will become better understood with reference to the following description and appended claims.

### DETAILED DESCRIPTION OF THE INVENTION

To the extent that this description is specific, it is solely for the purpose of illustrating certain embodiments of the invention and should not be taken as limiting the present inventive concepts to these specific embodiments.

Core Layer

The core layer of the multilayer film of the present invention can be a single core layer or plural core sub-layers. The core layer comprises a polyolefin selected from the group consisting of isotactic PP homopolymer, EP copolymer, HDPE, and LLDPE. Isotactic PP homopolymer is particularly preferred. Any of these materials, as well as the polyolefins of other layers, may be Ziegler-Natta catalyzed or metallocene-catalyzed, or combinations thereof. The core layer will generally have two surfaces, a first and a second surface.

Polypropylene copolymers, if used in the core layer, may include one or more comonomers selected from one or more of ethylene or butene. The propylene will be present in such co or terpolymers at >90 weight percent. Propylene polymers contemplated will generally have a melting point ≧140° C., or ≧150° C. Examples of propylene polymers include Fina 3371 (commercially available from Fina Oil and Chemical Company), and P 4252 (commercially available from ExxonMobil Chemical Company).

Melt flow ratios (MFRS) of the polypropylene polymers may range from 0.5 to 8 or 1.5 to 5 dg/min. Melt indices of the ethylene based polymers may range from 0.5 to 15 g/10 min.

Useful ethylene polymers include, but are not limited to HDPE M-6211 and HDPE M-6030 from Equistar Chemical Company; and HD-6704.67 from ExxonMobil Chemical Co.

The core layer of embodiments of our invention will have a thickness in the range of from 3-71 microns, preferably 10-40 microns, say, 12-30 microns.

The core layer may contain microscopic voids and/or 1-15, or 1-8, or 2-4 weight % of an opacifying agent, selected from one of iron oxide, carbon black, aluminum, TiO₂, talc, or combinations thereof.

Void-initiating particles, which may be added as filler to the polymer matrix material of the core layer, can be any suitable organic or inorganic material which is incompatible with the core material at the temperature of biaxial orientation, such as polybutene terephthalate (PBT), nylon, solid or hollow preformed glass spheres, metal beads or spheres, ceramic spheres, calcium carbonate, or combinations thereof.

The average diameter of the void-initiating particles may be from 0.1 to 10 microns. These particles may be of any desired shape or they may be substantially spherical in shape. This does not mean that every void is the same size. It means generally each void tends to be of like shape when like particles are used even though they vary in dimensions. These voids may assume a shape defined by two opposed and edge contacting concave disks. These void initiating particles will be present in the core layer at ≦20 weight percent, or ≦15 weight percent, or ≦10 weight percent, typically in the range of from 1-10 weight percent, based on the total weight of the core layer.

The two average major void dimensions are greater than 30 microns.

The void-initiating particle material, as indicated above, may be incompatible with the core material, at least at the temperature of biaxial orientation.

The core has been described above as being a thermoplastic polymer matrix material within which is located a strata of voids. The voids create the matrix configuration. The term “strata” is intended to convey that there are many voids creating the matrix and the voids themselves may be oriented so that the two major dimensions are aligned in correspondence with the direction of orientation of the polymeric film structure. As described herein above, iron oxide in an amount of from 1-8 wt. %, preferably 2-4 wt. % and aluminum in an amount of from 0-1.0 wt. %, preferably 0.25 wt. %-0.85 wt. % are added to the core matrix. Carbon black may also be used in lieu of some or all of the iron oxide.

A typical void of the core is defined as having major dimensions X and Y and minor dimensions Z, where dimension X is aligned with machine direction orientation, dimension Y is aligned with transverse direction orientation and dimension Z approximately corresponds to the cross-sectional dimension of the spherical particle which initiated the void.

Orientation conditions may be such that the X and Y dimensions of the voids of the core by major dimensions in comparison to the Z dimension. Thus, while the Z dimension generally approximates the cross-sectional dimension of the spherical particle initiating the void, X and Y dimensions may be significantly greater.

Polypropylene may be oriented at a temperature higher than its glass transition temperature. The temperature conditions may permit X and Y to be at least several multiples of the Z dimension, without void splitting. As indicated above, the matrix polymer and the void initiating particle may be incompatible and this term is used in the sense that the materials are two distinct phases. The spherical void initiating particles constitute a dispersed phase throughout the lower melting polymer which polymer will, ultimately, upon orientation, become a void-filled matrix with the spherical particles positioned somewhere in the voids.

The core layer may also contain a hydrocarbon resin. Examples of such hydrocarbon resins may be found in U.S. Pat. No. 5,667,902, incorporated herein by reference. The resin may be a low molecular weight hydrocarbon which is compatible with the core polymer. The resin may, optionally, be hydrogenated. The resin may have a number average molecular weight <5000, or <2000, or in the range of from 500-1000. The resin can be natural or synthetic and may have a softening point in the range of from 60°-180° C. examples of hydrocarbon resins include, but are not limited to petroleum resins, terpene resins, styrene resins and cyclopentadiene resins.

Examples of commercially available hydrogenated resins are those including Piccolyte®, Regalrez®, Regalite®, available from Hercules Corp., and Escorez®, available from ExxonMobil Chemical Co.

One particular resin may be referred to as a saturated alicyclic resin. Such resins, if used, may have a softening point in the range of from 85-140° C., or 100°-140° C., as measured by the ring and ball technique. Examples of commercially available saturated alicyclic resins are Arkon-P®, available from Arakawa Forest Chemical Industries, Ltd., of Japan.

The core layer may contain <15%, or <10% by weight of any such resins described above, singly or in any combination or in the range of from 2-10% by weight, or in some cases a different level 1-5% by weight, or 6-12% by weight.

Additionally, the core layer may contain more than one of the ingredients discussed above.

The core layer may comprise at least about 60 percent, preferably 80 to 95 percent of the total thickness of the film. The total thickness of the film ranges from 5 to 75 microns, preferably from about 15 to 35 microns. so the core layer can range from 3 to 71 microns, preferably from 12 to 30 microns.

In those instances wherein the external side of the core layer is exposed, the external side of the core layer can be flame, plasma, or corona discharge treated. It can also be desirable to coat the exterior side of the core layer with a coating selected from the group consisting of acrylics, PVDC, and PVOH.

Transition Layer

A transition layer (or tie layer) is present in the multilayer film of the present invention. The first transition layer can be positioned exterior to one side of the core layer. Optionally, a second transition layer can be positioned exterior to the other side of the core layer as well. The transition layer comprises a polyolefin selected from the group consisting of syndiotactic PP, EP copolymer, PB copolymer, EPB terpolymer, MDPE, metallocene-catalyzed LLDPE, LDPE, metallocene-catalyzed PE, EVA copolymer, EMA copolymer; EMA copolymer and ionomer, e.g., Surlyn™ ionomer. The first and optional second transitional layers may be the same polymer composition, or different. The first and optional second transitional layers may be present in the film in the range of from 0.5-10 microns, or 0.5-8 microns or 0.7-5 microns, 0.7-4 microns, or 0.7-3 microns or 0.7-2 microns, each, the first and second tie layers may be the same or different thickness

The first tie layer can include in the range of from 0.05-2 weight % of an additive selected from one of amorphous silica, calcium carbonate, magnesium silicate, aluminum silicate, calcium phosphate, crosslinked polymethacrylate, polymethyl silsesquioxane, polycarbonate, polyamide, polyester, Teflon® powder or combinations thereof, the weight % based on the total weight of the first tie layer, wherein the additive has a mean particle size in the range of from 0.5-20 microns, and a mean particle size of >10% of the thickness of the first tie layer; and at least a first skin layer contiguous to the first tie layer, such that the first tie layer is spaced between the core and the first skin layer.

Skin Layer

The skin layer present in the multilayer film of the present invention. The first skin layer is positioned exterior to the first transition layer. Optionally, a second skin layer can be positioned exterior to the second transition layer as well. Each skin layer comprises a polyolefin selected from the group consisting of PP homopolymer, HDPE, LLDPE, MDPE, EP copolymer, PB copolymer, and EPB terpolymer. The skin layer can provide a COF for the film, as determined by ASTM D 1894, of less than 1.5. Each skin layer is at least 0.5 micron in thickness, preferably from about 0.5 to 1.0 microns. Each skin layer has a melting point at least 5° C., preferably at least 10° C., say, at least 15° C. greater than the transition layer.

The skin layer(s) can further comprise an anti-blocking agent. Typical inorganic anti-blocks that may be used in multilayer films of embodiments of our invention include, but are not limited to, amorphous silica, calcium carbonate, magnesium silicate, aluminum silicate, calcium phosphate, or combinations thereof. Typical organic anti-blocks that may be used in multilayer films of embodiments of our invention include, but are not limited to, crosslinked polymethacrylate (Epostar® MA, available from Nippon Shokubai), polymethylsilsesquioxane (Tospearl®, available from Toshiba Silicon Co.), benzoguanamine formaldehyde, polycarbonate, polyamide, polyester, Teflon® powder, or combinations thereof. Also contemplated are combinations of organic and inorganic anti-blocks. Typical loadings of such anti-block or combinations of anti-block, in each layer, may be in the range of from 0.05-2 weight percent, or 0.075-1.5 weight percent, or 0.1-1 weight percent, or 0.1-0.5 weight percent, based on the total weight of the layer containing the anti-block. The anti-block (mean) particle sizes contemplated in embodiments of our invention are in the range of from 0.1-20 μm, or 0.5-20 μm, or 0.5-15 μm, or 1-10 μm.

In embodiments of our invention, the anti-block particle size may be larger in mean particle size than the thickness of the tie layer or layers of which it is a part. The mean particle size may be >10% or >20% or >30% or >40% or >60% or >80% or >100% or >120% or >140% or >160% or >180% than the thickness of the tie layer or skin layers.

The skin layer may be present in the film at thicknesses of 0.5-5μ, preferably 0.5-2μ, or more preferably 0.5-1. μA second skin layer, if present will be present in the range of from 0.5-5μ, preferably 0.5-2μ, or more preferably 0.5-1 μm.

Coating

The first skin layer can be coated with a suitable coating. One or more coatings may be applied to one or more skin layers may include techniques such as coating with acrylic polymers, polyvinylidene chloride (PVDC), ethylene acrylic acid copolymers (EAA), ethylene methyl acrylate copolymers (EMA), or poly(vinyl)alcohol (PVOH).

Acrylic coatings can be derived from any of the terpolymeric compositions disclosed in U.S. Pat. Nos. 3,753,769, and 4,865,908, the contents of which are incorporated by reference herein. These coating compositions contain as a film forming component, a resin including an interpolymer of (a) from 2 to 15 or from 2.5 to 6 parts by weight of an alpha-beta monoethylenically unsaturated carboxylic acid selected including one or more of acrylic acid, methacrylic acid, or mixtures thereof, and (b) from 85 to 98 or from 94 to 97.5 parts by weight of neutral monomer esters, the neutral monomer esters including (1) methyl acrylate or ethyl acrylate and (2) methyl methacrylate. These interpolymer compositions are further characterized by including from 30 percent to 55 percent by weight of methyl methacrylate when the alkyl acrylate is methyl acrylate and from 52.5 percent to 69 percent by weight of methylmethacrylate when the alkyl acrylate is ethyl acrylate. As more fully described infra, such coating compositions can be applied to the films herein in a variety of ways including in the form of ammoniacal solutions.

Similarly useful are copolymeric coating compositions prepared from the foregoing neutral monomer esters. These coating compositions are advantageously applied to the film laminates in the form of emulsions.

The coating can also be based on any of the known and conventional polyvinylidene chloride (PVDC) compositions heretofore employed as coatings in film manufacturing operations, e.g., any of the PVDC materials described in U.S. Pat. Nos. 4,214,039; 4,447,494; 4,961,992; 5,019,447; and 5,057,177.

U.S. Pat. No. 5,230,963 discloses enhancing oxygen barrier of films by a method involving a coating, both of which are incorporated herein by reference, or with prior application of a primer layer to enhance adhesion of the PVDC coating layer to the film surface to which it is applied. Commercially available PVDC latexes having a vinylidene chloride content of at least 50% or from 75% to 92% may be employed. The PVDC can also be provided as a copolymer of vinylidene chloride and one or more other ethylenically unsaturated comonomers including alpha, beta ethylenically unsaturated acids such as acrylic and methacrylic acids; alkyl esters containing 1-18 carbon atoms of the acids, such as methylmethacrylate, ethyl acrylate, butyl acrylate, etc. In addition alpha, beta ethylenically unsaturated nitrites such as acrylonitrile and methacrylonitrile and monovinyl aromatic compounds such as styrene and vinyl chloride comonomers can be employed. Specific PVDC latexes contemplated include: 82% by weight vinylidene chloride, 14% by weight ethyl acrylate and 4% by weight acrylic acid. Alternatively a polymer latex including 80% by weight vinylidene chloride, 17% methyl acrylate and 3% by weight methacrylic acid can likewise be employed.

The vinyl alcohol polymers, which may be used as coatings, can be any commercially available material. For example, Vinol 125, 99.3+% super hydrolyzed polyvinyl alcohol, or VINOL 325, 98% hydrolyzed polyvinyl alcohol obtained from Air Products, Inc. Application of a PVOH coating is further described in U.S. Pat. No. 5,230,963, incorporated herein by reference.

Before applying the coating composition to the appropriate substrate, the upper surface of the film may be treated as noted herein to increase its surface energy. This treatment can be accomplished employing known techniques, such as, for example, film chlorination, i.e., exposure of the film surface to gaseous chlorine, treatment with oxidizing agents such as chromic acid, hot air or steam treatment, flame treatment and the like. Although any of these techniques is effectively employed to pretreat the film surface, another method of treatment is an electronic treatment method which includes exposing the film surface to a high voltage corona discharge while passing the film between a pair of spaced electrodes. After electronic treatment of the film surface, the coating composition is then applied thereto.

An intermediate primer coating can also be employed. In this case, the film may be first treated by one of the foregoing methods to provide increased active adhesive sites thereon and to the thus treated film surface there may be subsequently applied a continuous coating of a primer material. Such primer materials are well known in the art and include, for example, epoxy and poly(ethylene imine) (PEI) materials. U.S. Pat. Nos. 3,753,769 to Steiner, 4,058,645 to Steiner and 4,439,493 to Hein et al., incorporated herein by reference, disclose the use and application of such primers. The primer provides an overall adhesively active surface for thorough and secure bonding with the subsequently applied coating composition and can be applied to the film by conventional solution coating means, for example, by mating roller application.

The coating composition can be applied to the film as a solution, one prepared with an organic solvent such as an alcohol, ketone, ester, and the like. However, since the coating composition can contain insoluble, finely divided inorganic materials which may be difficult to keep well dispersed in organic solvents, it is preferable that the coating composition be applied to the treated surface in any convenient manner, such as by gravure coating, roll coating, dipping, spraying, and the like. The excess aqueous solution can be removed by squeeze rolls, doctor knives, and the like.

The film can be stretched in the machine direction, coated with the coating composition and then stretched perpendicularly in the transverse direction. In yet another embodiment, the coating can be carried out after biaxial orientation is completed.

The coating composition may be applied in such amount that there will be deposited upon drying a smooth, evenly distributed layer, generally on the order of from 0.01-0.2 mil (0.25-5μ) thickness (equivalent to 0.2-3.5 g per 1000 sq. in. of film). Generally, the coating will be present from 1 to 25 wt % or 7 to 15 wt % of the entire coated film composition, based on the total weight of the multilayer film. The coating on the film may subsequently be dried by hot air, radiant heat or by any other convenient means.

Orientation

Embodiments of our invention include possible orientation of the multilayer films. Orientation in the direction of extrusion is known as machine direction orientation (MD), orientation perpendicular to direction of extrusion is known as transverse direction (TD). Orientation may be accomplished by stretching or pulling a blown film in the MD, using the blow-up ratio to accomplish TD orientation, or both may be used. Blown films or cast films may also be oriented by a tenter frame orientation subsequent to the film formation process, again in one or both directions. Orientation ratios may generally be in the range of 1:1-1:15 or MD 1:4-1:10 or in TD 1:7-1:12.

Treating

One or more of the exposed or outer most surfaces of the multilayer films of embodiments of our invention can be surface-treated to render them receptive to metallization, coating, printing inks or lamination. The surface treatment can be carried out according to one of the methods known in the art. Suitable methods include corona treatment, flame treatment, plasma, or treatment by means of a polarized flame. Generally the treated surface of films of embodiments of our invention will be treated on the outermost surface of the composite film that is opposite the layer containing the antiblock additives.

Surface Property Measurement

Coefficient of Friction (COF) is a measure of surface properties. Such measure is made by ASTM D 1894. COF is conventionally measured in this test at room temperature (22° C.) and for embodiments of our invention, room temperature COF will be <2 or <1.5 or <1.25 or <1.0 or <0.9 or <0.8, or <0.7 Another measure of COF is hot slip, measured at 135° C. (275° F.). For embodiments of our invention hot slip can be <2, preferably <1.9, or more preferably <1.85, or even more preferably <1.8. Both COF tests will generally be done on an untreated surface to itself. If there are two untreated surfaces, one will be selected, and tested to itself.

Metallization

Generally one of the skin layers will be a layer that may be metallized. However, if no skin layer is utilized, a core layer surface may be metallized. Such metallization may include vacuum metallization through deposition of a metal selected from the group consisting of aluminum, gold and silver.

Other Ingredients

Other ingredients in embodiments of our inventive blends include, but are not limited to, pigments, colorants, antioxidants, antiozonants, antifogs, antistats, fillers such as calcium carbonate, diatomaceous earth, carbon black, combinations thereof, and the like. Such additives may be used in effective amounts, which vary depending upon the property required, and are, typically selected from one or more of anti-block, slip additive, antioxidant additive, moisture barrier additive or gas barrier additive.

Useful antistatic additives which can be used in amounts ranging from 0.05 to about 3 weight %, based upon the weight of the layer, include alkali metal sulfonates, polyether-modified polydiorganosiloxanes, polyalkylphenylsiloxanes and tertiary amines.

Typical slip additives include higher aliphatic acid amides, higher aliphatic acid esters, waxes and metal soaps which can be used in amounts ranging from 0.1-2 weight percent based on the total weight of the layer. An example of a useful fatty amide slip additive is erucamide.

A conventional silicone oil or gum additive having a viscosity of 10,000-2,000,000 cSt. is also contemplated.

Useful antioxidants are, generally used in amounts ranging from 0.1 weight %-2 weight percent, based on the total weight of the layer, phenolic anti-oxidants. One useful antioxidant is commercially available under the trademark “Irganox 1010” (Ciba-Geigy).

Barrier additives are used in useful amounts and may include low-molecular weight resins, hydrocarbon resins, particularly petroleum resins, styrene resins, cyclopentadiene resins and terpene resins.

Optionally, the skin layers may be compounded with a wax for lubricity. Amounts of wax range from 2-15 weight % based on the total weight of the layer. Any conventional wax useful in thermoplastic films is contemplated.

Definitions and Testing Protocols

| | |
|---|---|
| Melt Flow Rate (MFR): | ASTM D 1238, condition L |
| Melt Index (MI): | ASTM D 1238, condition E |
| COF | ASTM D 1894 (room temperature, 22° C.) |
| Hot Slip | COF (measured at 135° C.) |

In those instances where the core layer comprises HDPE, the transition layer preferably comprises a polyolefin selected from the group consisting of metallocene-catalyzed LLDPE, LDPE, metallocene-catalyzed PE, EVA copolymer, EMA copolymer; EMA copolymer, and ionomer, e.g., DuPont's Surlyn™ ionomer, and the skin layer preferably comprises a polyolefin selected from the group consisting of HDPE, MDPE, and LLDPE.

In those instances wherein the core layer comprises isotactic PP homopolymer, the transition layer preferably comprises a polyolefin selected from the group consisting of EP copolymer, EPB terpolymer, PB copolymer, metallocene-catalyzed LLDPE, and syndiotactic PP, and the skin layer comprises a polyolefin selected from the group consisting of HDPE, MDPE and LLDPE. In a specific embodiment for multilayer films wherein the core layer comprises isotactic polypropylene polymer, the multilayer film can additionally comprise a first transition layer comprising a polyolefin selected from the group consisting of EP copolymer, EPB terpolymer, PB copolymer, metallocene-catalyzed LLDPE, and syndiotactic PP; a first skin layer exterior to said first transition layer wherein said first skin layer is HDPE, MDPE, and LLDPE; a second transition layer exterior to said core layer and on a side of said core layer opposite to said first transition layer, wherein said second transition layer comprises a polyolefin selected from the group consisting of EP copolymer, EPB terpolymer, PB copolymer, metallocene-catalyzed LLDPE, syndiotactic PP, and PP homopolymer; and a second skin layer external to said second transition layer, wherein said second skin layer is selected from the group consisting of HDPE, MDPE and LLDPE.

For purposes of the present invention, EP copolymers can refer to both random copolymers and block copolymers. Illustrative of EP random copolymers which can be used for both skin layers and transition layers of the present film are ethylene-propylene random copolymers containing from about 1.5 to about 10, and preferably from about 3 to about 5 weight percent ethylene. Illustrative of EP block copolymers which can be used for only the skin layers, and not the transition layers of the present film are ethylene-propylene block copolymers containing from about 3 to about 40 percent by weight ethylene, and preferably from about 10 to 25 percent by weight ethylene. The distinction between EP copolymers as it relates to the present invention will be readily apparent in the typical 5-layer structure immediately preceding Example 1.

Illustrative of EPB terpolymer copolymers which can be used for both skin layers and transition layers of the present film are ethylene-propylene-butene terpolymers containing from about 1 to about 10, and preferably from about 2 to about 6 weight percent ethylene and from about 80 to about 97, and preferably from about 88 to about 95 weight percent propylene.

Illustrative of PB copolymers which can be used for both skin layers and transition layers of the present film are propylene-butene-1 copolymers containing from about 5 to about 20 weight percent butene-1, and preferably from about 7 to 15 percent by weight butene-1.

A typical 5-layer heat sealable coextruded structure of the present invention showing some representative polyolefins for the tie layers and skin layers is set out below. The skin layers can be made of a reduced width while the tie/transition layers and PP homopolymer core are maintained at a greater width in relation to the skin layers.

Treated or Untreated

Higher melting PP homopolymer, EP block copolymer, HDPE,
higher melting EP random copolymer, PB copolymer, EPB
terpolymer, MDPE, LLDPE (0.5-2.0 micron thickness)
Lower melting EP random or PB copolymer, EPB terpolymer,
MDPE, metallocene-catalyzed LLDPE, LDPE, EVA, EMA,
Surlyn ® ionomer (0.5-5.0 micron thickness)
Isotactic PP homopolymer (5-50 micron thickness)
Lower melting EP random or PB copolymer, EPB terpolymer,
MDPE, metallocene-catalyzed LLDPE, LDPE, EVA, EMA,
Surlyn ® ionomer (0.5-5.0 micron thickness)
Higher melting PP homopolymer, EP block copolymer, HDPE,
EP random copolymer, PB copolymer, EPB terpolymer, MDPE,
LLDPE (0.5-2.0 micron thickness)

### EXAMPLE 1

Five layer coextruded polypropylene based films were prepared on a pilot biax line. Films were oriented in the machine and transverse direction. Skin layer resin type, tie (transition) layer resin type, skin layer thickness, and tie (transition) layer thickness were varied in accordance with the Table shown below. All films were tested for TMI COF (kinetic), Minimum seal initiation temperature (MST), and Hot Tack strength.

Sealability was tested on the films to measure the temperature at which seals are initiated and their strength after initiation. Seal strength was evaluated to determine the sealability of the film. In the examples, the minimum seal temperature was determined using a Wrap-Aide Crimp Sealer Model J or K. In the test method, the crimp sealer is set to a dial pressure of about 20 psi (138 kPa), and dwell time of 0.75 seconds. A film specimen is prepared so that when two surfaces are placed together the resulting film is approximately 6.35 cm in the transverse direction by 7.62 cm in the machine direction. The specimen is then inserted squarely, smoothly and flatly into the crimp sealer jaws so that a small amount protrudes beyond the back end of the jaws. The transverse direction of the film is parallel to the sealer jaws. The jaws are closed and immediately after the sealing bar rises the specimen is removed from the jaws of the sealer. A JDC cutter is used to cut the film into a one inch (2.5 cm) strip. The amount of force needed to separate the seal is determined on an Alfred-Suter crimp seal strength testing unit. The amount of force needed to pull the seal apart is recorded in N/m or g/in. In order to determine the minimum temperature required to form a seal requiring about 77.03 N/m (200 g/in) peel force, the crimp seals are formed at temperatures raised by 2.8° centigrade increments until one temperature yields a seal value of less than about 77.03 N/m and the next temperature yields a seal value of greater than or equal to about 77.03 N/m.

A chart method (using an established chart) for 77.03 N/m minimum seal temperature (MST) is used or a calculation is used. In the calculation method the following equation is employed:

[{(77.03 N/m−V1)/(V2−V1)}·(2.8)]+T1=MST in °C.;

where V1=seal value obtained prior to achieving 77.03 N/m

V2=seal value obtained subsequent to achieving 77.03 N/m

2.8=2.8° C. increment in seal temperature

T1=temperature prior to achieving 77.03 N/m.

The relationship between film structure/composition and film properties is also shown in the Table below. Comparative examples shown consisted of films with a polypropylene homopolymer tie layer.

TABLE

| | | | Tie/Transi- | | | | |
|---|---|---|---|---|---|---|---|
| | Outside Skin | Tie or | tion layer | | | Melting Point | |
| Outside Skin | Thickness | Transition | Thickness | MST | TMI COF | Differential | |
| Layer | (microns) | Layer | (microns) | (° C.) | (kinetic) | (deg. C)* | Hot Tack |
| EP | 0.508 | PP homo.- | 2 | 123 | 0.44 | −12 | Marginal |
| Random | | comparative | | | | | |
| Copolymer | | example | | | | | |
| (Fina 6573) | 0.508 | EPB | 2 | 112 | 1.07 | 25 | Good |
| | | terpolymer- | | | | | |
| | | Chisso 7800 | | | | | |
| EPB | 0.508 | PP homo.- | 2 | 113 | 0.61 | −27 | Marginal |
| Terpolymer- | | comparative | | | | | |
| Chisso 7400 | | example | | | | | |
| | 0.508 | EPB | 2 | 102 | 0.98 | 10 | Good |
| | | terpolymer- | | | | | |
| | | Chisso 7800 | | | | | |
| EPB | 0.75 | PP homo.- | 0.75 | 107 | 0.28 | −35 | Not |
| Terpolymer- | | comparative | | | | | Measured |
| Chisso 7700 | | example | | | | | |
| Same | 0.75 | Metall. | 0.75 | 100 | 0.41 | 55 | Not |
| | | LLDPE | | | | | Measured |
| Same | 0.75 | Metall. | 2.0 | 101 | 0.27 | 55 | Not |
| | | LLDPE | | | | | Measured |
| HDPE | 0.508 | PP homo.- | 2 | 117 | 0.29 | −30 | Poor |
| | | comparative | | | | | |
| | | example | | | | | |
| HDPE | 0.508 | EPB- Chisso | 1 | 117 | 0.36 | 8 | Marginal |
| | | 7800 | | | | | |
| HDPE | 0.508 | Metall. | 1 | 106 | 1.3 | 55 | Marginal |
| | | LLDPE | | | | | |

*Melting Point Differential is defined as the difference between the Peak DSC Melting point of the skin layer resin minus the Peak DSC Melting point of the Tie layer (Transition layer) resin.

The data generated from these experiments show that when sealable polyolefins are used in the tie layer with a thin sealable skin layer, improved sealability (as measured by a lower minimum sealing temperature (MST)) and improved hot tack can be achieved compared to the case where a PP homopolymer is used in the tie layer. Hence, films with improved seal range and hot tack can be produced by utilizing sealable-type polyolefins in the tie-layer. From the Table, it can be seen that the MST improvement is more dramatic when the skin and tie-layer consist of polyolefins of the same class (either propylene or ethylene based). A further benefit would be that since the lower melting point polyolefin is positioned in the tie layer as opposed to the skin layer, there will be improved orienter processability. Some of the very low melting point metallocene based LLDPE seal resins are very difficult if not impossible to process as a skin layer. Hence the sealability benefits of these resins can be realized by incorporation as a tie layer without all the processing difficulties.

The present invention thus provides coextruded, heat sealable OPP films with improved fitness-for-use, e.g., skin layer to tie layer interfacial melt instability, sealability, and hot tack and fitness-for-make (more robust casting process with HDPE skin layers, less MDO sticking, less sticking to clips, less scratching, etc.) than is available in the prior art.

### EXAMPLE 2

Five layer coextruded polypropylene based clear films were prepared using five extruders and a feedblock using a DDCAABEE selector plug, and multimanifold die having four distinct cavities. The D layer was on the waterbath side and the E layer was on the cast roll side. Equistar M6030A was utilized on both skins (D and E layers) to produce films with two skins of HDPE. The multilayer melt emerging from the die was cast onto a standard cast roll/water bath quench system. Film variables of 20 micron total thickness were produced with intermediate tie layers between the isotactic PP homopolymer core (Fina 3371) and the two HDPE skins consisting of EP random copolymer (Fina EOD 94-21), EPB terpolymer (Chisso XPM 7800), and syndiotactic PP (Fina EOD26-30). In addition, a control film variable with an intermediate tie layer of isotactic PP homopolymer (Fina 3371) was also produced. Films with HDPE skin thickness of 0.5 and 1.0 micron skin thicknesses were produced. Intermediate tie layer thicknesses were 2.0 microns. Reduced skin die inserts were utilized for both the D and E layer (HDPE skins) to leave both edges of the base sheet void of HDPE. The width of the reduced skin of HDPE on the cast roll side was one inch (2.5 cm) per side. The width of the base sheet coming off the cast roll was eleven inches (28 cm) wide. Hence, 18% of the cast roll side width was void of HDPE skin. Both the cast roll and waterbath temperatures were 100° F. (38° C.).

Acceptable results were obtained using EP copolymer, EPB terpolymer or syndiotactic PP as transition layer in terms of base sheet quality and uniformity, as well as edge wander of the base sheet coming off the caster section. The resulting base sheet was easy to stretch in the machine direction at five times at a cast roll speed of 36 feet per minute (11 meters per minute). Results were unacceptable with PP homopolymer tie layers because of poor base sheet quality and uniformity from difficulties associated with adequate adhesion of the polyethylene skin layer to the cast roll.

Although the present invention has been described in considerable detail with reference to certain embodiments thereof, other embodiments are possible. Therefore, the spirit and scope of the appended claims should not be limited to the description of the embodiments contained herein.

It is claimed:

1. A thermoplastic multilayer film comprising:
a) a core layer comprising a polyolefin selected from the group consisting of isotactic PP homopolymer, EP copolymer, HDPE, and LLDPE;
b) a first transition layer external to said core layer wherein said first transition layer comprises a polyolefin selected from the group consisting of syndiotactic PP, EP copolymer, PB copolymer, EPB terpolymer, MDPE, LLDPE, LDPE, metallocene-catalyzed PE, EVA copolymer, EMA copolymer, and ionomer; and
c) a first skin layer external to the first transition layer and the core layer wherein said first skin layer comprises a polyolefin selected from the group consisting of PP homopolymer, HDPE, EP copolymer, PB copolymer, EPB terpolymer, MDPE, and LLDPE, said first skin layer being at least 0.5 micron in thickness with a melting point at least 5° C. greater than said first transition layer.

2. The multilayer film of claim 1 wherein said melting point is at least 10° C. greater than said first transition layer.

3. The multilayer film of claim 1 wherein said melting point is at least 15° C. greater than said first transition layer.

4. The multilayer film of claim 1 wherein said core layer comprises HDPE and said first skin layer comprises a polyolefin selected from the group consisting of HDPE, MDPE, and LLDPE.

5. The multilayer film of claim 2 wherein said core layer comprises isotactic PP homopolymer, said first transition layer comprises a polyolefin selected from the group consisting of syndiotactic PP, EP copolymer, PB copolymer, EPB terpolymer, and metallocene-catalyzed LLDPE; and said first skin layer comprises a polyolefin selected from the group consisting of PP homopolymer, HDPE, EP copolymer, PB copolymer, and EPB terpolymer.

6. The multilayer film of claim 1 wherein said core layer comprises isotactic PP homopolymer, said first transition layer comprises a polyolefin selected from the group consisting of syndiotactic PP, EP copolymer, EPB terpolymer, and PB copolymer, and metallocene-catalyzed LLDPE, said first skin layer comprises a polyolefin selected from the group consisting of HDPE, LLDPE, and MDPE, said multilayer film further comprising:
d) a second transition layer external to said core layer and on a side of said core layer opposite said first transition layer, said second transition layer comprising a polyolefin selected from the group consisting of EP copolymer, EPB terpolymer, PB copolymer, syndiotactic PP, metallocene-catalyzed LLDPE, and PP homopolymer; and
e) a second skin layer external to said second transition layer and on a side of said core layer opposite said first skin layer, said second skin layer comprising a polyolefin selected from the group consisting of HDPE, MDPE, and LLDPE, said second skin layer being at least 0.5 micron in thickness with a melting point at least 5° C. greater than said second transition layer.

7. The multilayer film of claim 2 wherein said core layer comprises isotactic PP homopolymer, said first transition layer comprises a polyolefin selected from the group consisting of syndiotactic PP, EP copolymer, EPB terpolymer, and PB copolymer, and metallocene-catalyzed LLDPE, said first skin layer comprises a polyolefin selected from the group consisting of PP homopolymer, HDPE, EP copolymer, PB copolymer, and EPB terpolymer, said multilayer film further comprising:
d) a second transition layer external to said core layer and on a side of said core layer opposite said first transition layer, said second transition layer comprising a polyolefin selected from the group consisting of syndiotactic PP, EP copolymer, EPB terpolymer, and PB copolymer, and metallocene-catalyzed LLDPE, and
e) a second skin layer external to said second transition layer and on a side of said core layer opposite said first skin layer, said second skin layer comprising a polyolefin selected from the group consisting of PP homopolymer, HDPE, EP copolymer, PB copolymer, and EPB terpolymer, said second skin layer being at least 0.5 micron in thickness with a melting point at least 5° C. greater than said second transition layer.

8. The multilayer film of claim 1 wherein said first skin layer further comprises an anti-blocking agent and wherein at least a major proportion of the anti-blocking agent is in the form of particles of approximately spherical shape.

9. The multilayer film of claim 8 wherein said anti-blocking agent is selected from the group consisting of amorphous silica, cross-linked methacrylate, and polymethylsilsesquioxane.

10. The multilayer film of claim 9, wherein said core layer further comprises an additive selected from the group consisting of:
i) an opacifying agent selected from the group consisting of iron oxide, carbon black, aluminum, TiO₂, and talc, said opacifying agent being present in said core layer in an amount ranging from about 1 wt % to about 15 wt %, based on the total weight of the core layer;
ii) a cavitating agent selected from the group consisting of polybutene teraphthalate, nylon, solid glass spheres, hollow glass spheres, metal beads, metal spheres, ceramic spheres, and CaCO₃, said cavitating agent being present in said core layer in an amount ranging from about 1 wt % to about 20 wt %, based on the total weight of the core layer, said cavitating agent having a mean particle size in the range of from 0.1 micron to 10 microns; and
iii) a hydrocarbon resin selected from the group consisting of petroleum resin, terpene resin, styrene resin, cyclopentadiene resin, and saturated alicyclic resin, said resin having an average molecular weight of less than about 5000, a softening point in the range of from about 60° to about 180° C., and said resin being present in said core layer at less than about 15 wt %, based on the total weight of the core layer.

11. The multilayer film of claim 1 wherein the core layer comprises at least about 60 percent of the total thickness of the film.

12. The multilayer film of claim 1 wherein the total thickness of the film is from about 7 to about 75 microns.

13. The multilayer film of claim 1 wherein said first transition layer has a thickness of about 0.5 to about 10 microns.

14. The multilayer film of claim 1 wherein an exposed surface of said first skin layer is treated by a procedure selected from the group consisting of corona treatment, flame treatment, and plasma treatment.

15. The multilayer film of claim 1 wherein an exposed surface of said core layer is treated by a procedure selected from the group consisting of corona treatment, flame treatment, and plasma treatment.

16. The multilayer film of claim 1 wherein said first skin layer is coated with a coating selected from the group consisting of acrylics, PVDC, and PVOH.

17. The multilayer film of claim 1 wherein an external side of said core layer is coated with a coating selected from the group consisting of acrylics, PVDC, and PVOH.

18. The multilayer film of claim 1 wherein an external side of said first skin layer is vacuum metallized with aluminum.

19. The multilayer film of claim 1 further comprising a second skin layer on a side of said core layer opposite said first skin layer.

20. The multilayer film of claim 19 wherein said second skin layer comprises a polyolefin selected from the group consisting of PP homopolymer, EP copolymer, EPB terpolymer, PB copolymer, MDPE, LLDPE, and HDPE.

21. The multilayer film of claim 19 further comprising a second transition layer interposed between said core layer and said second skin layer.

22. The multilayer film of claim 21 wherein said second transition layer is selected from the group consisting of syndiotactic PP, EP copolymer, PB copolymer, EPB terpolymer, and metallocene-catalyzed LLDPE.

23. The multilayer film of claim 1 wherein said first skin layer has a variation in thickness of no greater than 0.1 micron.

24. The multilayer film of claim 1 which has improved processability compared to a corresponding film differing in melting point between the first skin layer and first transition layer by less than 5° C., as characterized by at least one of improved adhesion to the cast roll, improved MDO draw line stability, less MDO roll sticking, fewer web breaks in the MDO, less of a propensity for surface scratching, less sticking to the TDO clips, and less downtime for roll cleaning.

25. The multilayer film of claim 1 which has improved sealability as characterized by minimum seal temperature, and hot tack strength.

26. A thermoplastic multilayer film comprising:
a) a core layer comprising HDPE;
b) a first transition layer external to said core layer wherein said first transition layer comprises a polyolefin selected from the group consisting of syndiotactic PP, EP copolymer, PB copolymer, EPB terpolymer, MDPE, LLDPE, LDPE, metallocene-catalyzed LLDPE, EVA copolymer, EMA copolymer, and ionomer; and
c) a first skin layer external to the first transition layer and the core layer wherein said first skin layer comprises a polyolefin selected from the group consisting of HDPE, MDPE, and LLDPE, said first skin layer being at least 0.5 micron in thickness with a melting point at least 5° C. greater than said first transition layer.

27. A thermoplastic multilayer film comprising:
a) a core layer comprising isotactic PP homopolymer;
b) a first transition layer external to said core layer wherein said first transition layer comprises a polyolefin selected from the group consisting of EP copolymer, EPB terpolymer, PB copolymer, metallocene-catalyzed LLDPE, and syndiotactic PP;
c) a first skin layer external to said first transition layer and said core layer wherein said first skin layer comprises a polyolefin selected from the group consisting of HDPE, LLDPE, and MDPE, said first skin layer being at least 0.5 micron in thickness.

28. The multilayer film of claim 27 which further comprises:
d) a second transition layer external to said core layer and on a side of said core layer opposite said first transition layer, said second transition layer comprising a polyolefin selected from the group consisting of EP copolymer, EPB terpolymer, PB copolymer, syndiotactic PP, metallocene-catalyzed LLDPE, and PP homopolymer; and
e) a second skin layer external to said second transition layer and on a side of said core layer opposite said first skin layer, said second skin layer being at least 0.5 micron in thickness and comprising a polyolefin selected from the group consisting of HDPE, MDPE, and LLDPE.

29. The multilayer film of claim 27 wherein said first skin layer has a melting point at least 5° C. greater than said first transition layer.

30. The multilayer film of claim 28 wherein said first skin layer has a melting point at least 5° C. greater than said first transition layer and said second skin layer has a melting point at least 5° C. greater than said second transition layer.

31. A method of making a biaxially oriented, surface treated multilayer thermoplastic film comprising the steps of:
1) coextruding a multilayer melt of polyolefin polymers through a die, said melt comprising
a) a core layer comprising a polyolefin selected from the group consisting of isotactic PP homopolymer, EP copolymer, HDPE, and LLDPE;
b) a first transition layer external to said core layer wherein said first transition layer comprises a polyolefin selected from the group consisting of syndiotactic PP, EP copolymer, PB copolymer, EPB terpolymer, MDPE, LLDPE, LDPE, metallocene-catalyzed PE, EVA copolymer, EMA copolymer, and ionomer; and
c) a first skin layer external to the first transition layer and the core layer wherein said first skin layer comprises a polyolefin selected from the group consisting of PP homopolymer, HDPE, EP copolymer, PB copolymer, EPB terpolymer, MDPE, and LLDPE, said first skin layer being at least 0.5 micron in thickness with a melting point at least 5° C. greater than said first transition layer;
2) cooling said multilayer melt to form a multilayer film;
3) stretching said multilayer film in the machine direction (MD) over heated rollers traveling at a differential speed to form an MD oriented multilayer film;
4) stretching said MD oriented multilayer film in transverse direction in a heated tenter frame to form a biaxially oriented multilayer film; and
5) surface treating one or more exposed surfaces of said biaxially oriented multilayer film with a treatment selected from the group consisting of corona treatment, flame treatment, and plasma treatment.

32. The method of claim 31 wherein said first skin layer comprises a polyolefin selected from the group consisting of HDPE, MDPE, and LLDPE.

33. The method of claim 31 wherein said cooling is carried out by contacting said first skin layer of said multilayer melt with a casting roll.

34. The method of claim 32 wherein said melt further comprises
d) a second transition layer external to said core layer and on a side of said core layer opposite said first transition layer, said second transition layer comprising a polyolefin selected from the group consisting of EP copolymer, EPB terpolymer, PB copolymer, syndiotactic PP, metallocene-catalyzed LLDPE, and PP homopolymer; and
e) a second skin layer external to said second transition layer and on a side of said core layer opposite said first skin layer, said second skin layer comprising a polyolefin selected from the group consisting of HDPE, MDPE, and LLDPE.

35. The method of claim 34 wherein said cooling is carried out by contacting said first skin layer of said multilayer melt with a casting roll and contacting said second skin layer of said multilayer melt with a water bath.

36. The method of claim 31 wherein the width of said first skin layer is narrower than its underlying transition layer.

37. The method of claim 36 wherein said width is sufficiently narrow to allow contact of said immediately underlying first transition layer of said first skin layer with said casting roll to an extent sufficient to increase friction between said multilayer melt and said casting roll as compared to a corresponding multilayer melt whose first skin layer and underlying first transition layer have the same width.

38. The method of claim 37 wherein said width of said first skin layer ranges from 70 to 95% of said first transition layer.

39. The method of claim 37 wherein said width of said first skin layer ranges from 75 to 85% of said first transition layer.

40. A thermoplastic multilayer film comprising:
A) a core layer comprising a polyolefin;
B) a first transition layer external to said core layer wherein said first transition layer comprises a polyolefin; and
C) a first skin layer external to said first transition layer wherein said first skin layer comprises a polyolefin, is at least 0.5 micron in thickness, and has a melting point at least 5° C. greater than said first transition layer;
said multilayer film having a variability in thickness no greater than 1.0 micron.
